(19) United States
(12) Patent Application Publication
(10) Pub. No.: US 2010/0091397 A1
(43) Pub. Date: Apr. 15, 2010

(54) SHIELD MEANS FOR DATA INPUT APPARATUS AND METHOD OF USE THEREOF

(76) Inventors: Paul Clancy, Leeds (GB); Gordon Birtwistle, Huddersfield (GB)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 12/527,310

(22) PCT Filed: Mar. 7, 2008
(86) PCT No.: PCT/GB08/00781

§ 371 Date: Aug. 14, 2009

(30) Foreign Application Priority Data
Mar. 9, 2007 (GB) 0704598.2
Apr. 5, 2007 (GB) 0706736.6

(51) Int. Cl. G02B 27/02; G06F 1/16

(52) U.S. Cl. 359/893; 361/679.02; 359/894

(57) ABSTRACT

Shield means are provided for use on data input apparatus. The shield means includes a housing or frame with at least one channel defined therethrough. The at least one channel has a first end and a second end and is arranged such that a user can view the first channel end in a first position when the user is looking through the second channel end and the user's line of vision is substantially parallel with the longitudinal axis of said channel, thereby allowing data and/or data input means associated with or below the first channel end to be viewed by the user in the first position. The view of the first channel end is substantially obscured or shielded from the user in at least a second position when the user's line of vision is at an acute angle to said channel longitudinal axis.

### CROSS-REFERENCE TO RELATED APPLICATIONS

This application is an U.S. national phase application under 35 U.S.C. §371 based upon co-pending International Application No. PCT/GB2008/000781 filed on Mar. 7, 2008. Additionally, this U.S. national phase application claims the benefit of priority of co-pending International Application No. PCT/GB2008/000781 filed on Mar. 7, 2008; Great Britain Application NO. 0704598.2 filed on Mar. 9, 2007; and Great Britain Application No. 0706736.6 filed on Apr. 5, 2007. The entire disclosures of the prior applications are incorporated herein by reference. The international application was published on Sep. 18, 2008 under Publication No. WO 2008/110759.

### BACKGROUND OF THE INVENTION

1. Field of the Invention

This invention relates to shield means for data input apparatus and a method of using said shield means.

2. Description of the Prior Art

It is known to provide apparatus in which a user has to input data before a process or transaction can be undertaken, such as for example in an automatic teller machine (ATM), a chip and pin card device, a computer system, a voting system, secure access door and/or the like. The data input into the apparatus is often in the form of identification data or data unique and/or confidential to the user and allows the apparatus to recognize the user and authorize the transaction or process. However, a problem with this form of recognition system is that if unauthorized third parties obtain this unique data, they can use the data to pose as the user and commit fraudulent acts, such as withdrawing money from an ATM without the user's permission, obtaining access to buildings without authority, obtaining chip and pin details relating to a user's credit and/or the like. A common method via which unauthorized third parties are managing to obtain the user's identification data is by what it known as “shoulder surfing”, wherein the third party stands behind or to the side of the user as the user inputs their secure data into data input apparatus and steals the data. The third party can then log themselves into the data input apparatus as the user at a later date or can steal the user's credit card for example having obtained the user's chip and pin data.

In an attempt to prevent fraud relating to unauthorized third parties obtaining and using a user's secure data, shielding devices have been provided around the data input apparatus to at least partly shield or obscure the data being input into the apparatus by the user from a third party. For example, on chip and pin data input devices, outwardly protruding side walls are often provided around the keypad in which the user's pin number is input, thereby shielding the keypad from a third party. However, conventional shield devices are not completely effective and unauthorized third parties are still managing to obtain user's secure data by shoulder surfing, using CCTV footage and/or the like.

### SUMMARY OF THE INVENTION

It is therefore an aim of the present invention to provide shield means for use on data input apparatus which improves the security of a user inputting data into said data input apparatus by reducing the visibility of said apparatus to an unauthorized third party.

It is a further aim of the present invention to provide data input apparatus with shield means.

It is a yet further aim of the present invention to provide a method of using shield means.

It is a yet further aim of the present invention to provide a method of using data input apparatus with shield means.

According to a first aspect of the present invention there is provided shield means for use on data input apparatus, said shield means including a housing or frame with at least one channel defined therethrough, said at least one channel having a first end and a second end and arranged such that a user can view the first channel end in a first position when the user is looking through the second channel end and the user's line of vision is substantially parallel with the longitudinal axis of said channel, thereby allowing data and/or data input means associated with or below the first channel end to be viewed by the user in the first position, the view of the first channel end being substantially obscured or shielded from the user in at least a second position when the user's line of vision is at an acute angle to said channel longitudinal axis.

Thus, the shield means of the present invention typically only allows a user to view the data and/or data input means of the data input apparatus when the user is looking through the first channel end in the first position, and prevents the user and/or unauthorized third party from viewing the data and/or data input apparatus when looking at the first channel at an angle. This significantly increases the security of the apparatus or data input apparatus on which the shield means is used, thereby reducing fraud.

The channel can be viewed directly and/or indirectly via one or more mirrors, lenses, cameras and/or the like.

Preferably the housing, frame and/or one or more side walls defining the at least one channel is formed from substantially non-transparent or opaque material, thereby preventing viewing of the second channel end through the side walls of the housing, frame and/or one or more channels. It is preferable to have some level of translucency of the material to ensure sufficient light enters the channels for the user to see what they are doing. However, additional illuminating means can be provided if required, such as an LED, light and/or the like.

Preferably the first and second channel ends are open ends and/or are formed from substantially transparent material, thereby allowing a user looking through said channel at the correct angle to view the first channel end from the second channel end.

In one embodiment the user may need to locate their hand and/or digit in said channel or an upper surface of said channel end to allow data input means associated with said channel to be actuated. In an alternative embodiment die user may simply view a data item via the channel and actuate data input means which are separate to said channel.

The data items associated with the channel or channels may be changed between each use to prevent an unauthorized third party from determining which data item is associated with which channel or position on the shield means. For example, the data items can be electronically changed or randomly shuffled between each use. The second channel end can be substantially flush with or recessed in an upper surface of the housing or frame. The channel can be defined between the upper and lower surface of the housing or frame or the channel can be in the form of a sleeve which protrudes below the lower surface of the housing or frame. In a further embodiment, the channel can protrude outwardly from an upper surface of the frame or housing, such as for example substantially perpendicular to an upper surface of the frame or housing. In this embodiment, the second channel end is substantially above the upper surface of the housing or frame. The first channel end can be located adjacent to the upper or lower surface of the housing or frame or can be located above or below the housing or frame as required.

The channel can be defined in a sleeve which protrudes at least partly above or below the frame or housing or can be defined in the housing or frame.

The data item or data input means can be integrally formed, attached to or detachably attached with an end or intermediate section of the channel. Alternatively, the data item or data input means can be a spaced distance below the first channel end. In the latter embodiment, this provides an option of the user inserting their hand or digit in the space between the shield means and the data input means to actuate the data input means directly.

In one embodiment a single channel is defined in the frame or housing and the side walls defining the channel and the user's head blocks the vision of a third party in the second viewing position.

In one embodiment a channel or aperture is defined in a frame or housing. The frame or housing could be provided in a sheet like form and the suitable shaped channel or aperture can be defined in said sheet like housing or frame to act as a viewing section. Preferably the frame, housing and/or channel is movable relative to data being viewed, such as a security document and/or the Eke, thereby allowing a user to view a relatively large document or data area. The frame could be movable in any required direction.

In one embodiment a plurality of channels are defined in the frame or housing. The channels can be any suitable shape, such as square, oblong slots, cylindrical and/or the like.

A different data item or different data input means can be associated with each different channel. Alternatively, a number of different data items or data input means can be viewed or accessed via a single channel and vice versa.

Preferably obscuring means are provided in, on or associated with the at least one channel to further obscure or shield the first channel end when a viewing party is in the second viewing position.

In one embodiment the obscuring means are in the form of a grid or honeycomb type of arrangement. The grid or honeycomb type of arrangement can be provided across a cross sectional area of the channel or can be provided substantially along the length of said channel.

In one embodiment the obscuring means includes a plurality of members arranged between the side walls and/or end walls of the at least one channel. The plurality of members can be provided transversally of the channel and/or longitudinally of the channel as required. For example, in one embodiment substantially vertical and/or horizontal members, blind like members, louvres and/or the like can be provided.

In one embodiment the one or more channels could be defined between louvre members.

The members can have one or more raised or etched surfaces provided thereon to retain the light passing through the material while confusing any image that may be viewable through, the material. For example, one or more perforations could be provided in the material from which the obscuring means and/or channel means are formed from, thereby allowing some light to pass through the material to aid viewing of the data item or data input means being viewed. The one or more perforations can be provided at any suitable angle in or through the material.

In one embodiment the channel means and/or obscuring means are provided with a reflective material or coating therein or thereon to increase light reflection, thereby increasing the visibility of the data item, data input means and/or the like being viewed.

The members of the obscuring means or the apertures of the grid or honeycomb arrangements are typically arranged so that the data item, data input means and/or data display means are at least partly visible when viewed by a party in the first position but are substantially obscured or shielded when viewed by a party in the second position. For example, the spacing between the members or apertures, the angle of the members or apertures relative to each other, the dimensions of the members or apertures and/or the like provide the necessary shielding capability.

Preferably the second position is achieved by viewing the second channel end at one or more other angles from a side and/or end of the shield means. Preferably the first position is achieved by viewing the second channel end substantially from above and/or directly in front of the second channel end and/or shield means.

Preferably first and second sets of members are provided. The members of the first set are typically arranged at an angle, such as substantially perpendicular to or at an acute angle to the members of the second set. The apertures created between the members allow a user to see through the obscuring means to the first channel end.

Preferably the members are substantially upright members. For example, the members can be of a sheet like form and the planar or flat surface of the members (i.e. the surface having the larger surface area) is substantially parallel to the longitudinal axis of the channel.

The members can be arranged at any angle or spacing relative to each other but preferably the members are arranged substantially parallel to each other.

In one embodiment the position of the members is adjustable using adjustment means to adjust the spacing and/or angles of one or more of said members. This is useful if the shield means is used in different positions, such as for example on a chip and pin device which may be located on a horizontal worksurface, provided at an angle on a stand and/or the like.

In one example, one or more channels are defined between louvre members and the louvre members are movable via adjustment means. The louvre members can be adjusted to any user selected or pre-determined position(s) to allow a user to view data and/or the like below the louvres.

The adjustment means typically includes user actuation means, such as a handle or button to allow the adjustment to be actuated.

Thus, in one embodiment a first set of upright members are provided and are arranged in a first orientation and at least a second set of upright members are provided and are arranged in a second, different orientation. Each set of upright members includes one or more of said members.

Preferably the at least second set of upright members is arranged substantially perpendicularly to the first set of upright members.

In a preferred embodiment the first set of upright members are arranged in a substantially horizontal orientation and the second set of upright members are arranged in a substantially vertical orientation.

The first and second set of members can be arranged to provide the grid like or honeycomb like formation.

Preferably the one or more members in each set have sufficient height to provide a honeycomb type of arrangement or a plurality of members are provided at spaced distances apart at different heights along the longitudinal axis of the channel.

The one or more members in the first and second sets can have substantially the same dimensions and/or can have substantially different dimensions.

Preferably each member is relatively thin, such as formed from a sheet like material. The thickness of the upright members is such so as to allow a user to view the data item, data input means and/or display means when viewing from the first position but to have the view substantially obscured when viewed from the second position.

The viewer typically views the data item, data input means and/or display means through the spaces or gaps defined between the members. The obscuring means or one or more upright members can be provided to protrude substantially perpendicularly with respect to an upper surface of the data item, data input means and/or display means. However, the one or more upright members can be provided to protrude at an acute angle relative to said upper surface.

The shield means can be detachably attached to the data item, data input means, data input apparatus, attached thereto or integrally formed therewith.

The obscuring means can be detachably attached, attached to or integrally formed with the at least one channel of the shield means.

In one embodiment the shield means and/or obscuring means can be retrofitted to any existing data input apparatus, data item and/or any data input means as required.

In one embodiment a recess or aperture is defined in a work surface, item of furniture, housing and/or the like. Data input means and/or display means are locatable in said recess or aperture and the shield means are positionable on or relative to an opening of said recess or aperture.

The shield means can be detachably attached, integrally formed or attached to the surface, item of furniture, housing and/or the like. The attachment means can include friction fitting, one or more screws, nuts and bolts, clips, ties, inter-engaging members, adhesive, welding, locking means and/or the like.

The shield means can be movable or movably mounted relative to said surface, item of furniture, housing and/or the like. For example, the shield means can be hingedly or pivotally mounted to a suitable surface, item of furniture, housing and/or the like.

In one embodiment the recess or aperture has a first opening and at least a second opening. The shield means can be associated with the first opening. A user can locate their hand and/or fingers in said at least second opening to allow access to said display means and/or said data input means.

In a preferred embodiment the first opening is defined in a top wall of a surface, item of furniture, housing and/or the like. A second opening, if provided, can be defined in a side wall of the surface, item of furniture, housing and/or the like.

For example, the surface, item of furniture, housing and/or the like could include a desk, checkout counter in a retail outlet, worksurface, Automatic Teller Machine, counter top, voting booth and/or the like. An item can be placed in the recess or aperture of and can be viewed by a user via the obscuring means. Thus, in this example, it is not necessary to have data input means and/or display means associated with the shield means and the invention simply provides a means for securely viewing one or more items located in a recess or aperture. The one or more items are preferably removably located in said recess or aperture. For example, the item could include a passport, security details, banking or financial details, voting form, data protection information, chemist prescriptions and/or the like.

The shield means are typically arranged over substantially the whole of the data item, data input means and/or display means. The shield means could protrude or extend beyond the edges of the data item, data input means and/or display means. The arrangement of members within the shield means can be substantially uniform or non-uniform as required. Different arrangement of members can be provided with different data items, data input means and/or display means on the same item of apparatus.

At least part of one or more of the members in the different sets can engage directly with each other or can be arranged so as to be seen to be engaged but are not actually engaged.

The data input apparatus on which the shield means can be used or associated with can include any or any combination of a chip and pin device, automatic teller machine, door entry device, biometric passport reading system, LD card reading system, electronic voting system, computer system, Internet, Internet Banking System and/or the like.

In one embodiment a plurality of data input means and/or display means are provided on said data input apparatus. Shield means can be associated with each individual data item, data input means and/or display means. Alternatively, single shield means can be associated with all the data items, data input means and/or display means.

The data input means can include any or any combination of one or more buttons, keys, levers, scroll devices, touch screen display, tracker ball, dials and/or the like.

The data items can be associated with display means which are different to the selection means via which a user can select the data items. For example, the numbers for selection can appear on keys, buttons, television screen and/or the like and the selection means can include a tracker ball, mouse, scroller, pointer, pen and/or the like. Preferably the data input means and/or display means are provided on or in a housing of the data input apparatus.

The one or more channels defined in the shield means can be in the form of one or more recesses, louvres or wells. Whilst first and second channel ends are used herein, it will be appreciated that the data item, data input means and/or the like could be located intermediate the first and second channel ends if required.

The one or more upright members are preferably located between the first and second channel ends of the shield means. However, one or more of the upright available in the public domain. The stand typically locates device 200 at a position and angle suitable for a user to input their pin number into chip and pin device 220. A recess 206 defined between the base of obscuring device 200 and the upper surface of chip and pin device 220 is of such dimensions to allow a user to insert their hand therein to select the buttons on device 220.

The wells 216 on device 200 can be formed from a plurality of first and second members 228, 230 located substantially-perpendicular to each other. First members 228 are located a spaced distance apart from each other and substantially parallel to each other. Second members 230 are also located a spaced distance apart from each other and substantially parallel to each other. The spaces between the members 228, 230 are sufficient to allow a user to see to the base of the wells when viewing the device 200 above in plan view but to hide the base of the wells from view when the device 200 is viewed from an angle to the side or end of the device.

The depth of the wells is typically dependent on the distance between the upper surface and lower surface between which the wells are defined. The depth is such so as to prevent a user from viewing a base of the wells when looking from a side or at an angle to the device.

FIG. 8a illustrates a further shield device 300 having outer side walls 302, 304 and end walls 306, 308. A plurality of substantially vertical members 310 and substantially horizontal members 312 are located at spaced apart intervals to define a plurality of wells 314 therebetween. In order to ensure the authorised authorized user is correctly positioned to allow the data to be easily viewed at the base of wells 314 without causing strain to the user's eyes, alignment or positioning means can be provided to indicate to the user when they are in a correct position. In the illustration, the positioning means includes four dots 316 located in each corner of device 300. The user is typically given instructions to align their head or eyes with the device 300 such that the total area of all four dots can be clearly seen, as shown in FIG. 8a, when the user's head is directly over device 300 (i.e. their line of vision is parallel to the longitudinal axis members could protrude above and/or below the first and/or second channel ends if required.

In one embodiment the data items can be displayed via the data input means or can be displayed on the display means associated with the data input apparatus. For example, data items can be associated with each of a plurality of data input means. The data items can be fixed or can be changed relative to the data input means or channels. For example, the data items can be electronically scrambled after each use of the data. input apparatus, such that a different data item is associated with a particular data input means for each new use of the apparatus. This further decreases the likelihood of a third party viewing the data input apparatus over the shoulder of a user or from the side of the apparatus from viewing the data items associated with the data input means. Alternatively the data input means can be movably mounted with respect to the housing of the apparatus. In one embodiment the data input means and/or the data items associated with the data input means and/or display means are fixed. The data items can be in the form of one or more numbers, characters, letters, symbols, images, Braille, blanks and/or the like.

The one or more channels can contact the data item, data input means and/or display means directly, be integral with or can be positioned a spaced distance therefrom, such as being attached to the housing.

In one embodiment the user may need to contact the shield means directly in order to select the data item. In an alternative embodiment cover means can be associated with the shield means, such as for example a transparent cover on a channel end, and the user contacts the cover means to actuate selection of the data item or data input means.

The upper and/or lower surface of the shield means can be substantially planar or flat in form. In one embodiment the upper and/or lower surface of the shield means is substantially curved or stepped in form.

Preferably positioning means are provided to allow a user to correctly position their self or align their self with respect to the shield means or data input apparatus to achieve the first viewing position. The positioning means can include one or more visual and/or audio markers located at one or more pre-determined positions on the shield means and/or data input apparatus to alert the user when a correct alignment position has been achieved.

The positioning means can also be used to ensure the user's head is sufficiently aligned above or with the data input means or apparatus to block out a third party's view of the data device if looking through a CCTV camera or security camera and/or the like.

According to a second aspect of the present invention there is provided data input apparatus including shield means. The data input apparatus can include data input means for inputting data into said apparatus and/or a data input display for displaying data.

According to a third aspect of the present invention there is provided a method of using shield means associated with data input apparatus, said shield means including a housing or frame with at least one channel defined therethrough, said at least one channel having a first end and a second end and wherein said method includes the steps of a user viewing the first channel end in a first position when the user is looking through the second channel end and the user's line of vision is substantially parallel with the longitudinal axis of said channel, thereby allowing data and/or data input means associated with or below the first channel end to be viewed by the user in the first position, the view of the first channel end being substantially obscured or shielded from the user in at least a second position when the user's line of vision is at an acute angle to said channel longitudinal axis.

According to fourth aspect of the present invention there is provided a method of using data input apparatus including shield means.

According to a further aspect of the present invention there is provided an item of furniture, housing, container or surface, at least one recess or aperture defined in said item of furniture, housing, container or surface and shield means associated with an opening of said at least one recess or aperture. In one embodiment shield means are associated with support means, a cover or stand. The support means, cover or stand can be removably associated, attached to or detachably attached with an item or device for which secure viewing of at least a part thereof is required. The support means, stand or cover is typically arranged so as to locate the shield means in a suitable position with respect to said at least part of the item or device. For example, the cover can be of slightly larger dimensions compared to the item or device on which the cover is at least partially located to allow a relatively tight fit. The stand with shield means can be removably placed over a keyboard for example when inputting secure details into a computer using said keyboard to allow the obscuring means to at least partially obscure the keystrokes made by a user of the keyboard. The stand can then be removed for normal typing using the keyboard so as not to obstruct the user.

The cover and/or stand can be made from plastic, leather, fabric, board, metal, wood and/or the like. The shield means can be attached to detachably attached to or integral with said cover and/or stand.

According to a yet further aspect of the present invention there is provide display means including shield means. The shield means can be located on, with or a spaced distance apart from said display means.

The shield means can be formed from any or any combination of suitable material, such as plastic, rubber, metal, wood, cardboard and/or the like.

According to one aspect of the present invention there is provided a manufacturing method for producing shield means by injection moulding (i.e. from a plastic material). According to one aspect of the present invention there is provided a manufacturing method for producing shield means using a die stamping process.

According to a further aspect of the present invention there is provided a method of producing shield means using one or more louvres to form one or more channels for viewing an object, data item and/or the like.

### BRIEF DESCRIPTION OF THE DRAWINGS

Embodiments of the present invention will now be described with reference to the accompanying figures, wherein:

FIGS. 1a and 1b illustrate a plan view and perspective view of data input apparatus according to one embodiment of the present invention respectively;

FIGS. 2a and 2b show a perspective view and plan view from above of the data input means and the shield means in FIGS. 1a and 1b with the housing of the data input apparatus removed respectively;

FIG. 3 is a detailed view of the shield means shown in FIGS. 1a-2b;

FIGS. 4a and 4b illustrate a perspective view of shield means associated with a worksurface in an “in-use” and “out of use” positioned respectively;

FIGS. 5a-5c illustrate show examples of the view seen by a user of the shield means in FIG. 4a when viewed in different positions;

FIGS. 6a-6d illustrate an end view, side view, perspective view and plan view of shield means according to a further embodiment of the present invention respectively, wherein the shield means is substantially curved or arced in form;

FIG. 7a is an example of the shield means in FIGS. 6a-6d located on a support for a chip and pin device;

FIG. 7b is a further example of the shield means in FIGS. 6a-6d using on a different type of chip and pin device;

FIGS. 8a and 8b show an example of means to allow a user to be informed of a correct viewing position and incorrect viewing position respectively when using shield means according to an embodiment of the present invention;

FIGS. 9a and 9b-9d illustrate two further examples of shield means according to embodiments of the present invention.

### DESCRIPTION OF THE PREFERRED EMBODIMENT

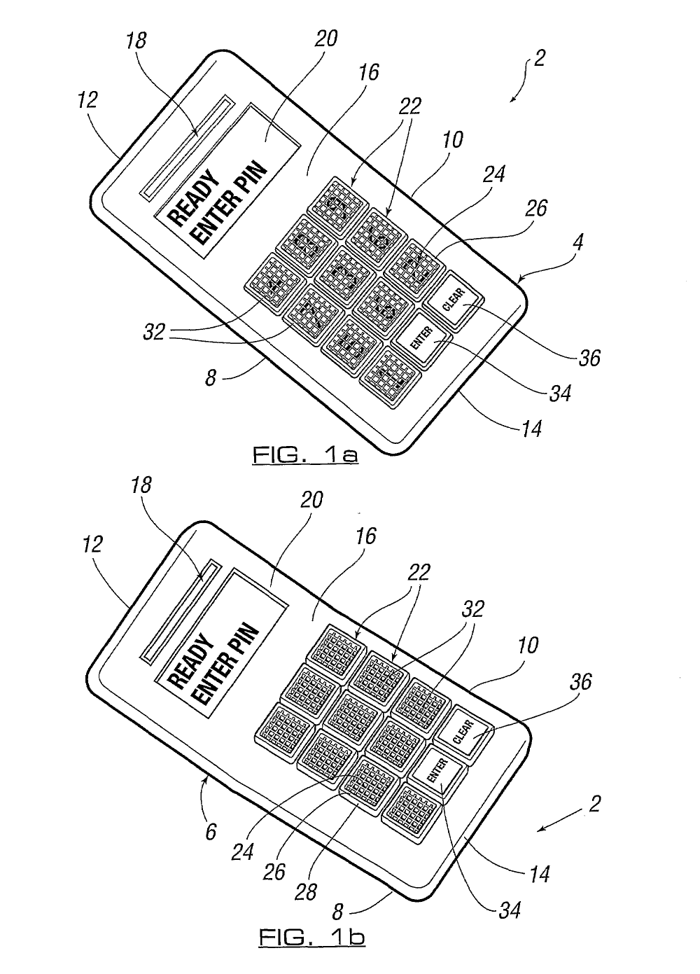

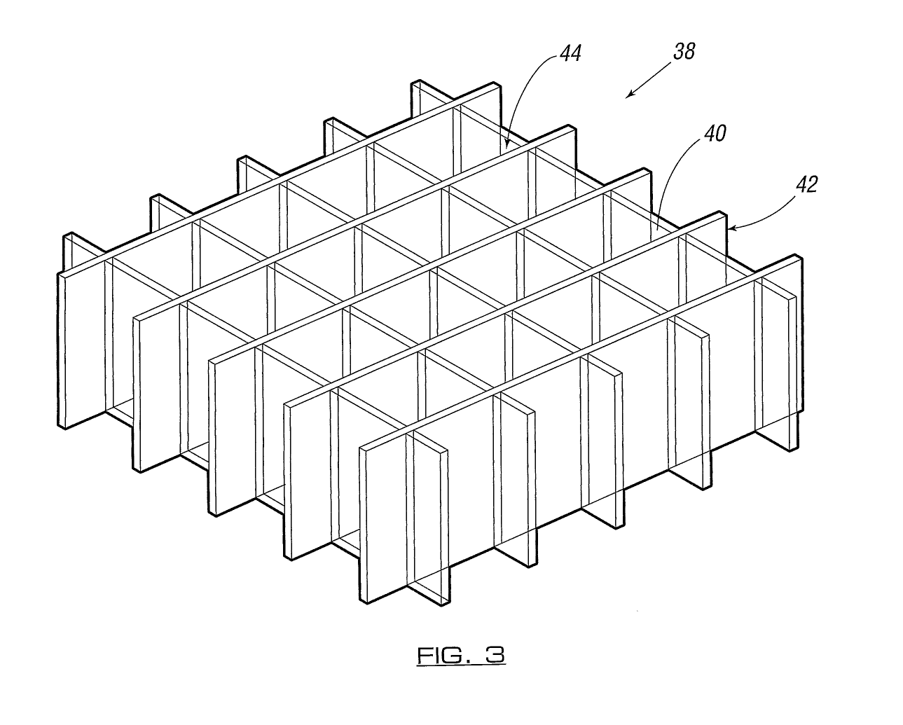

Referring to FIGS. 1a-3 there is illustrated a chip and pin data input apparatus 2. The apparatus 2 is used to allow a user to input a unique confidential pin number to allow authorization of a financial transaction to take place.

The apparatus 2 includes a housing 4 having a base 6, side walls 8, 10, end walls 12, 14 and a top 16. A slot 18 is provided on top 16 for the location of an end of a credit card with an electronic chip associated therewith. Chip reading means provided in the housing reads data from the electronic chip to allow processing of the financial transaction.

A display screen 20 is also provided on top 16 for displaying data thereon, such as instructions for the user for use of the apparatus 2. A plurality of wells 22 are defined at spaced apart intervals in top 16 of housing 4. Each well 22 has an opening 24 defined between upper edges 26 of side walls 28 which protrude outwardly from the surface of top 16. A data item in the form of a number 30 is located at the base of each well 22. The numbers 30 include numbers 0-9 to allow a user's pin code to be input into the apparatus. The side walls 28 of the wells are substantially opaque to stop a user from viewing the data item associated with a well from the side thereof.

A button 32 is movably mounted in each well 22 above the data item or with the data item. User depression of the button 32 with respect to well 22 using a user's finger signals to the apparatus the number 30 associated with well 22. An “enter” button 34 is provided to allow a user to enter any pin number or other data into the apparatus and a “clear” button 36 is provided to clear any data submitted to the apparatus in error.

The buttons 32 are typically formed from substantially transparent material to allow a user to view the numbers 30 located beneath the button.

In accordance with the present invention, shield means 38 are associated with buttons 32 to allow viewing of the data items associated with the buttons by a user at a first position (which may include one or more pre-determined angles), but to substantially obscure or shield the data items when the apparatus is viewed from at least a second position (which may include one or more other angles). More particularly the shield means includes a first set of upright members 40 and a second set of upright members 42 which define a plurality of channels or apertures therebetween. Each upright member 40, 42 is in a sheet or plate like form with the thinnest edge or depth of the member protruding outwardly from apparatus 2 and the length and width of the member being substantially parallel to the side walls 28 of well 22. The members of each set are a spaced distance apart and substantially parallel to each other. Upright members 40 are arranged substantially horizontally and upright members 42 are arranged substantially vertically. As such, upright members 40 are substantially perpendicular to upright members 42 to form a honeycomb or three dimensional grid type of arrangement.

In the illustrated example, an individual shield means 38 is embedded in each button 32 and moves with said buttons. The top edge of each upright member 40, 42 are substantially flush.

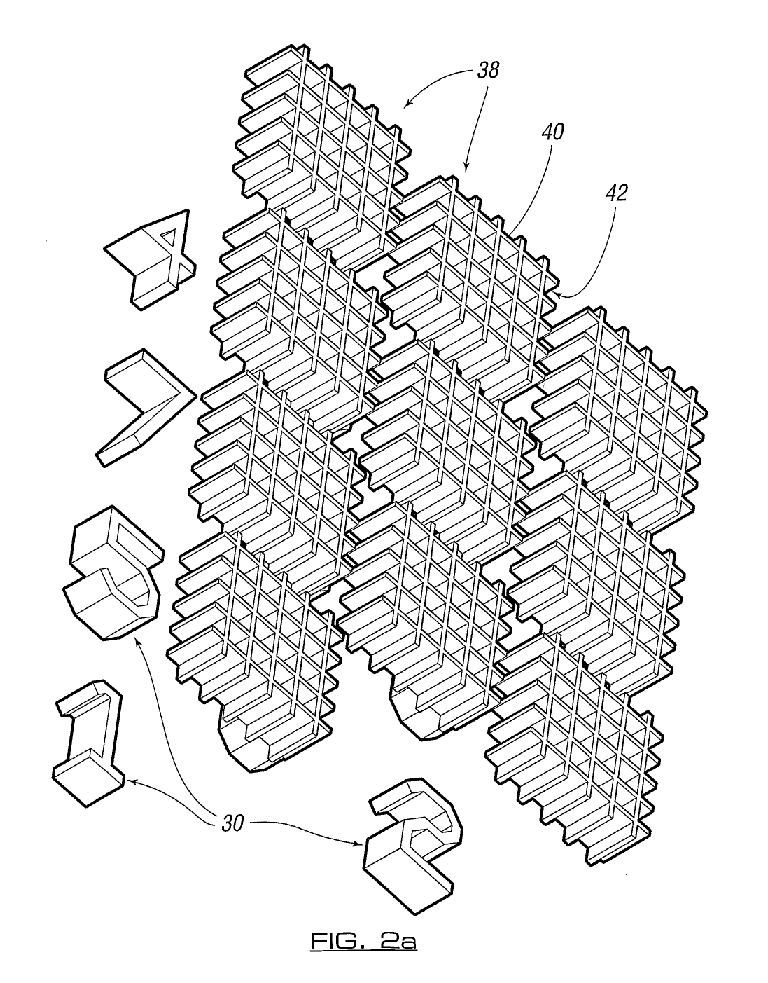

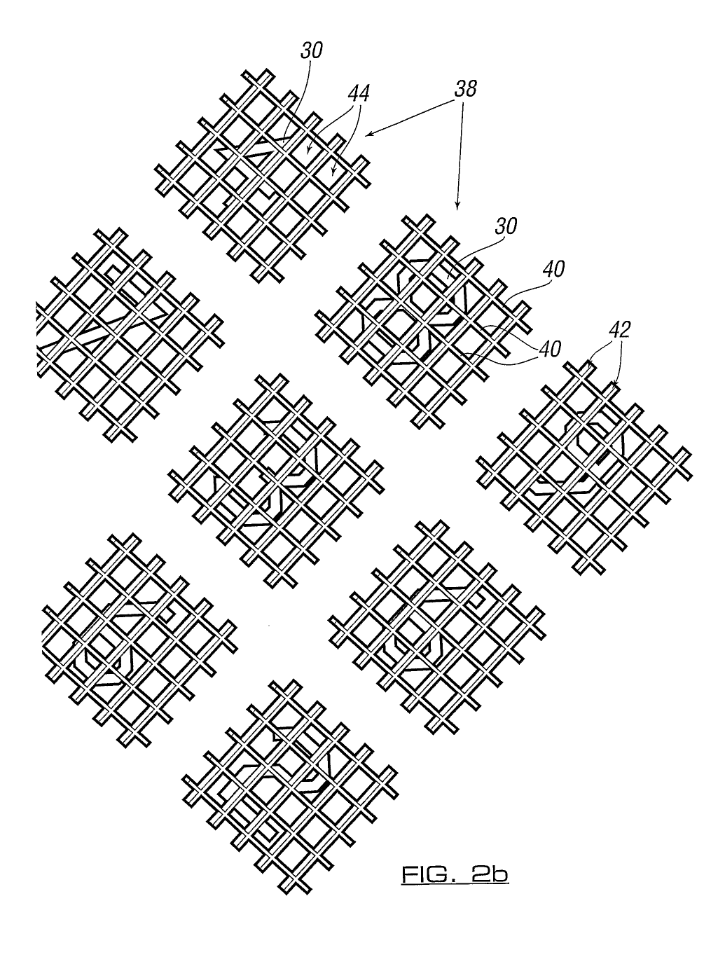

It can be seen that when buttons 32 are viewed in a predetermined angle in plan, as in FIGS. 1a and 2b, a user can view the numbers 30 through the gaps 44 defined between members 40, 42. However, when buttons 32 are viewed from another side angle, as shown in FIG. 1b, members 40, 42 substantially obscure the view of numbers 30. This helps to prevent third parties from fraudulently obtaining a user's pin number.

Scrambling means can be associated with the data input means to scramble the data associated with each button, such that an unauthorized third party cannot simply work out the data item being depressed just by looking at the position of the button on the data input means.

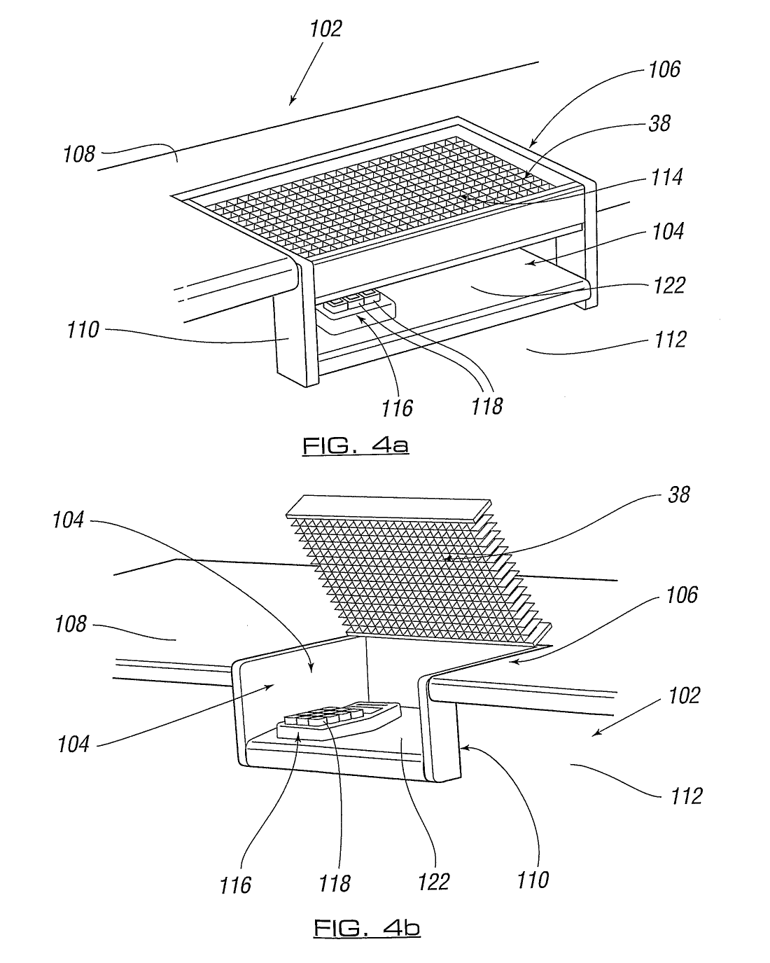

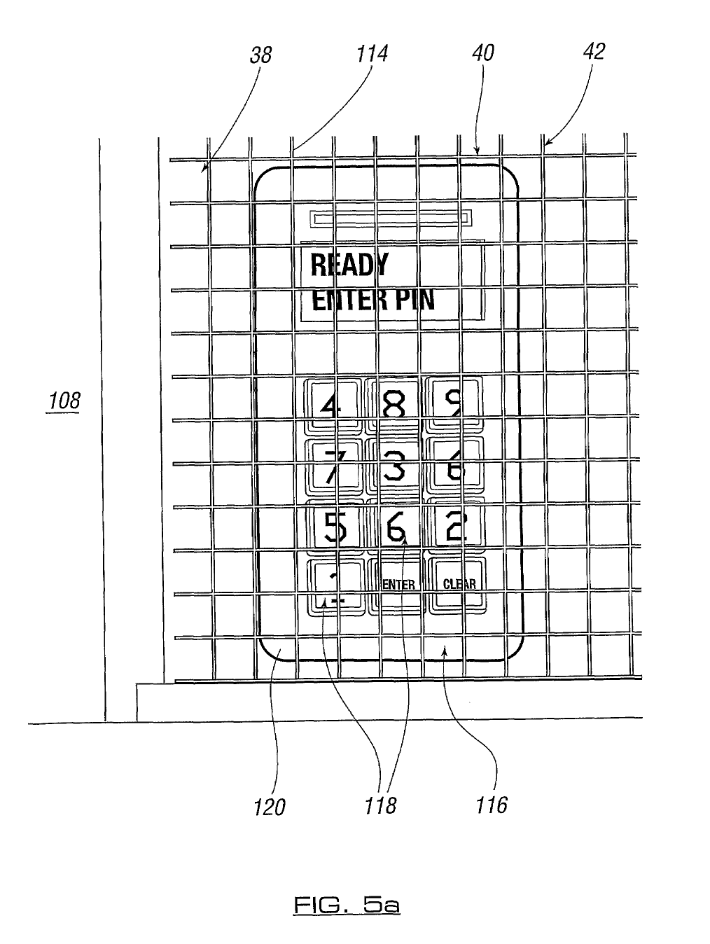

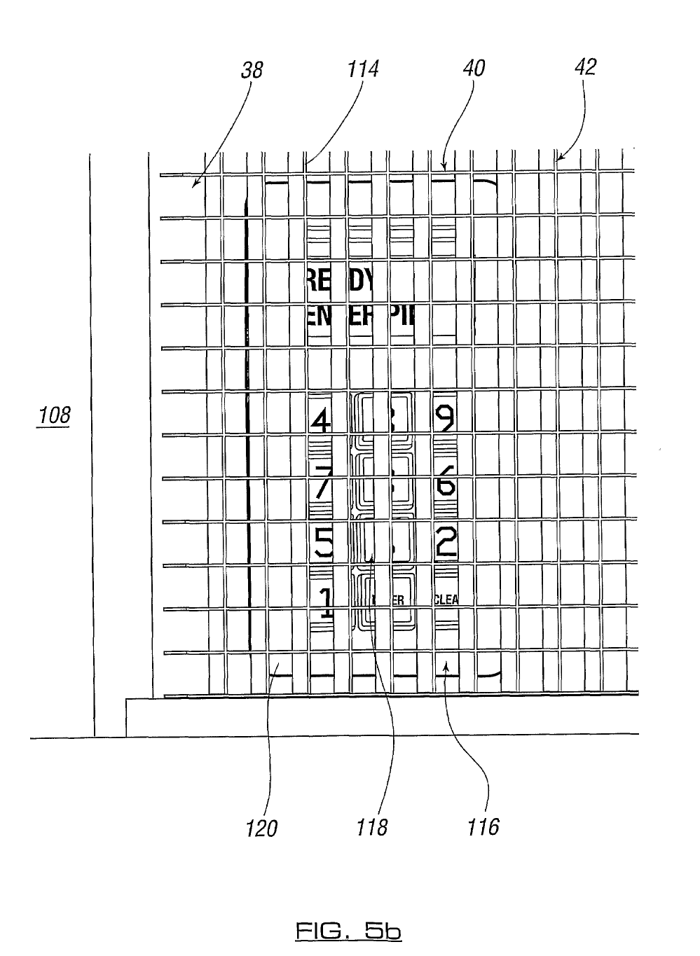

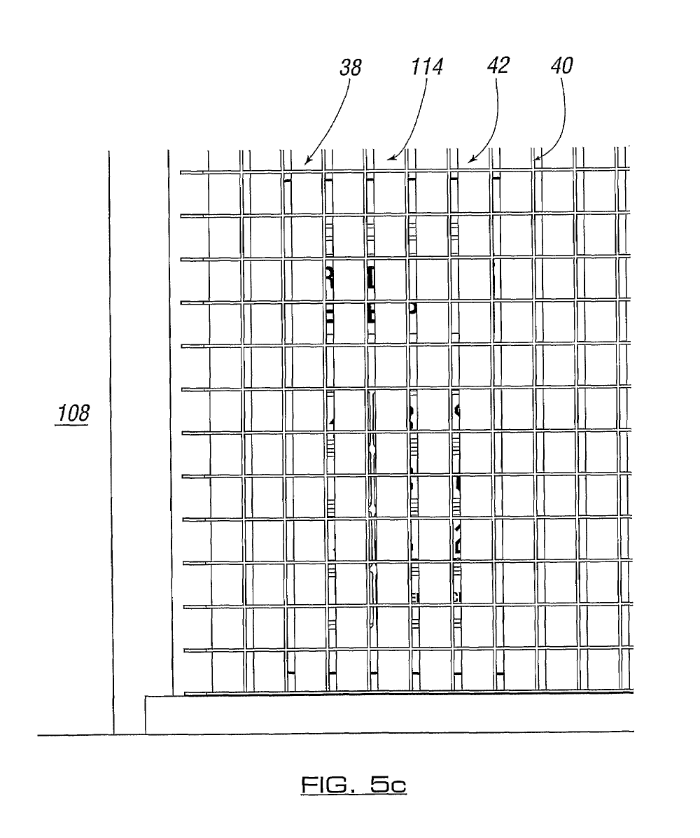

Referring to FIGS. 4a-5c, there is illustrated an item of furniture in the form of a retail counter 102. A recess 104 is defined in said counter 102 and the recess 104 has an opening 106 adjacent a top 108 of counter 102 and an opening 110 in a side 112 of counter 102. Shield means 38 are located relative to opening 106, such that a top surface 114 of the shield means is substantially flush with top 108 of counter 102.

Opening 110 is left at least partially uncovered to allow an item, which in this example is a chip and pin device 116, to be located in recess 104. The device 116 is typically located on a base of recess 104 but can be provided in the recess at any suitable location and/or orientation.

The chip and pin device 116 has data input buttons 118 provided on an upper surface 120 thereof to allow a pin number to be input into the device as previously described. With device 116 located on a base 122 of recess 104 a space is provided between the lower surface of obscuring means 38 and upper surface 120 of the device 116. The space is sufficient so as to allow a user to locate their hand through opening 110 to actuate buttons 118 to input the pin number and/or other suitable data into said device.

The shield means 38 functions in a similar manner to that previously described. Thus, FIG. 5a illustrates a user's view when viewing directly from above top surface 114 of shield means 38; the data input buttons 118 can be clearly viewed. FIG. 5b illustrates a user's view when viewed at a slight angle to top surface 114 of obscuring means 38; the data input buttons can be only partially viewed. FIG. 5c illustrates a third party view, such as a potential fraudster, retail assistant and/or the like, when trying to shoulder surf or look at top surface 114 of shield means 38 from any angle around the circumference of the device, such as behind, in front of or from the side of a user and/or the device; the data input buttons are substantially not visible due to the honeycomb type of obscuring means. Shield means 38 is hingedly attached to retail counter 102 and therefore movable between an “in-use position” as shown in FIG. 4a, and an “out of use” position, as shown in FIG. 4b, wherein the shield means 38 is raised to allow access through opening 106. The “out of use” position could allow a credit card to be inserted into the device 116 if the slot for the credit card is on a top surface of the device. A slot could be provided on the side of device 116 to allow a credit card to be inserted into device through opening 110 of recess 104. It will be appreciated that shield means 38 could be fixed or detachably attached to counter 102 if required.

The embodiment in FIGS. 4a and 4b is advantageous in that larger buttons can be provided on device 116 for use with Braille for blind people or partially sighted users without a third party being able to determine what buttons are being actuated by the user.

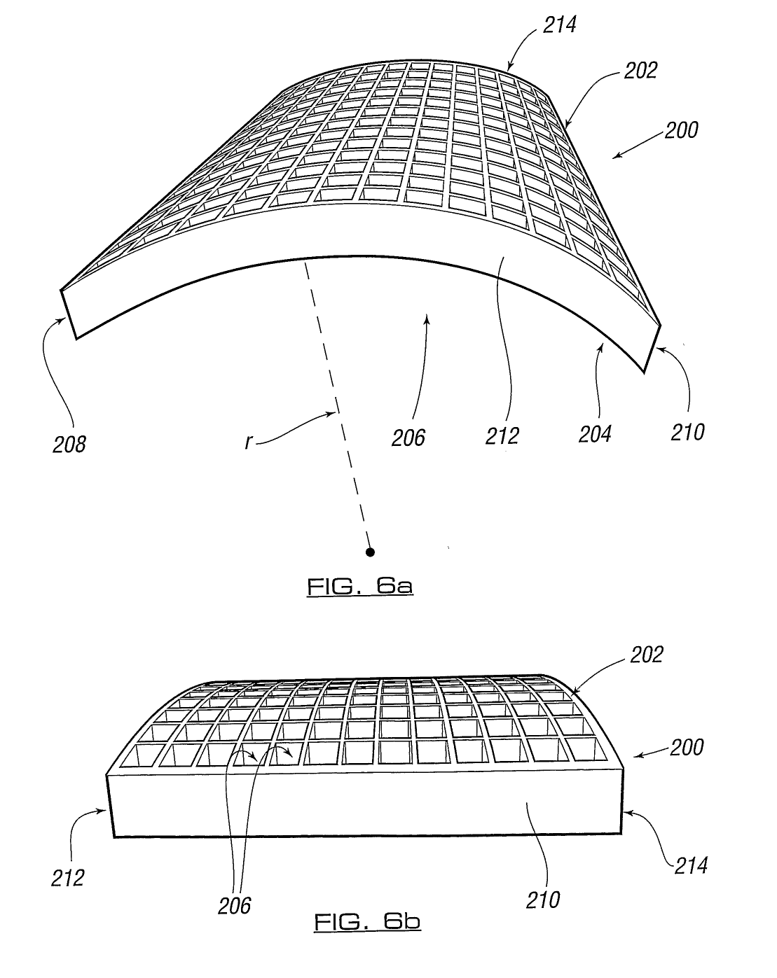

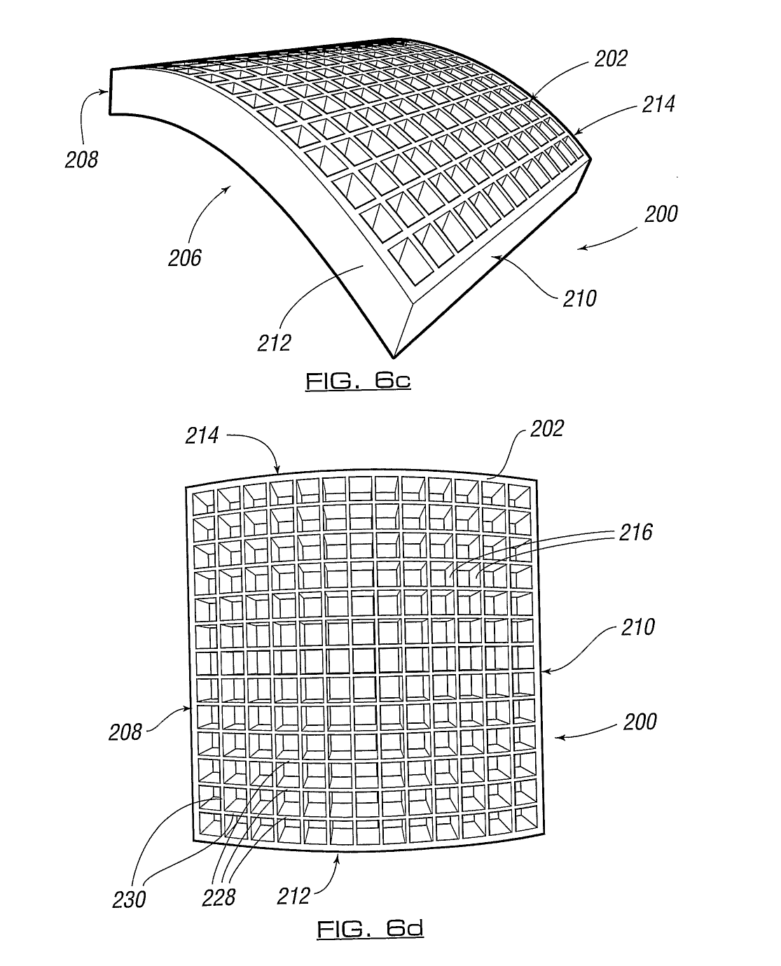

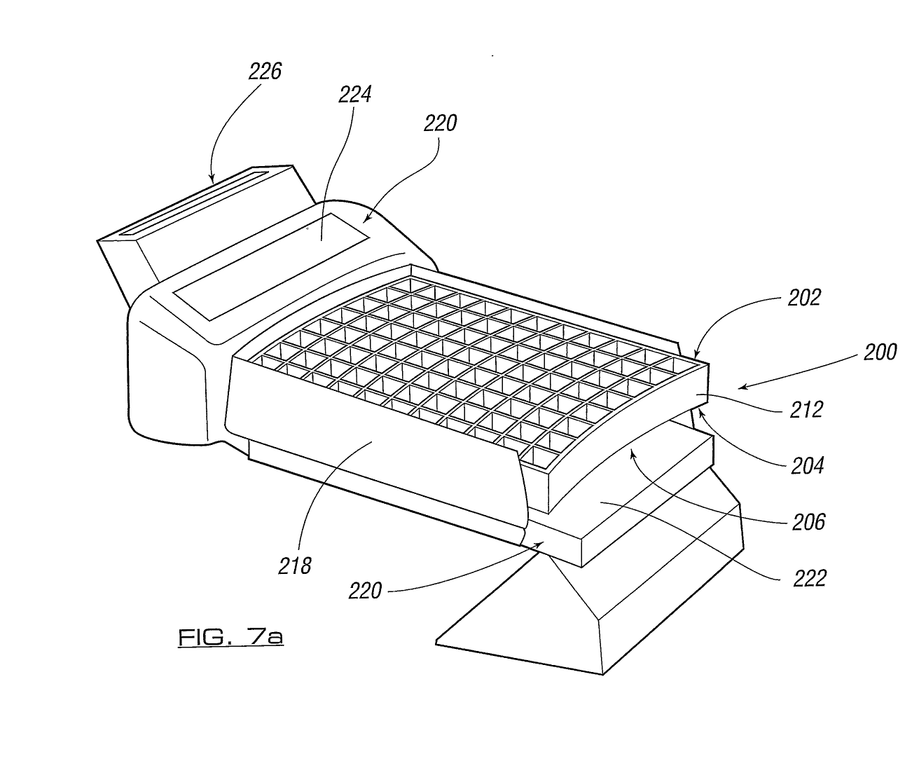

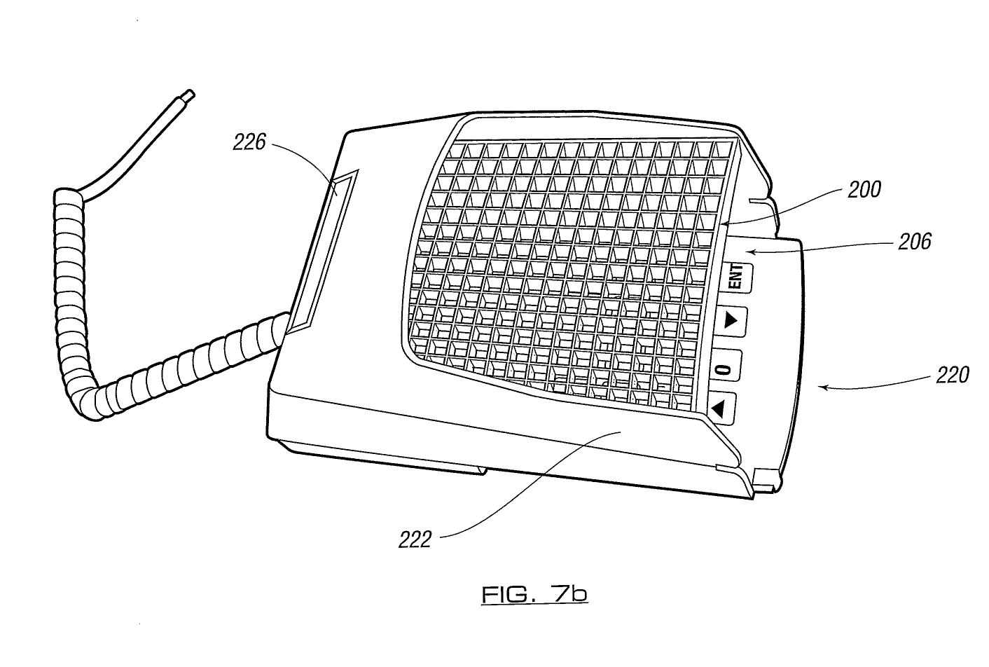

Referring to FIGS. 6a-7b, there is illustrated a further example of a shield device 200 wherein the upper or outer surface 202 is substantially convexed or curved in shape and the lower or inner surface 204 is substantially concave in form. The device 200 therefore provides a recess 206 adjacent the lower surface 204 thereof to allow a user to insert their hand or digit under the lower surface to actuate data input means.

The curvature of device 200 in this example is from a first side wall 208 to an opposite side wall 210, such that the side walls are lower than the centre top surface of the device. The lower surface 204 of the device typically forms an arc of a circle with the radius V extending below lower surface 204 to a “virtual” central position of a circle. The end walls 212, 214 are at substantially the same level. By making the device 200 curved in this way, this further obscures the view through wells 216 defined through the device between upper surface 202 and lower surface 204, as can be seen when device 200 is viewed from the end, side or an angle as shown in FIGS. 6a-6c. Only when the device 200 is viewed substantially in plan view from above, as shown in FIG. 6d, can the base of the wells 216, and thus data input means or data located at the base of the wells, be clearly seen.

The device can be curved from end 212 to end 214 is required, thereby making the device substantially dome shaped on an upper surface if required. Alternatively, the device can have a stepped incline or gradient on one or more walls thereof to ensure the wells are not visible to a third party looking from a side of the device.

The device 200 can be attached, detachably attached or integral with data input means as required. FIG. 7a illustrates how device 200 can be supported on a stand 218 a pre-determined distance above a chip and pin device 220. FIG. 7b illustrates how device 200 can be fitted directly to the body portion 222 of the chip and pin device 220.

More particularly, chip and pin device 220 includes a body portion 222 having a display screen 224 located on an upper surface thereof and a slot 226 for the insertion of a credit card therein in use. Buttons (not shown) are located under obscuring device 200 which can be depressed by a user to select one or more data items or number associated with the buttons.

Device 200 is supported on stand 218 via friction fit and could be easily removed if required, thereby allowing device 200 to be retrofitted to conventional stands already available in the public domain. The stand typically locates device 200 at a position and angle suitable for a user to input their pin number into chip and pin device 220. A recess 206 defined between the base of obscuring device 200 and the upper surface of chip and pin device 220 is of such dimensions to allow a user to insert their hand therein to select the buttons on device 220.

The wells 216 on device 200 can be formed from a plurality of first and second members 228, 230 located substantially-perpendicular to each other. First members 228 are located a spaced distance apart from each other and substantially parallel to each other. Second members 230 are also located a spaced distance apart from each other and substantially parallel to each other. The spaces between the members 228, 230 are sufficient to allow a user to see to the base of the wells when viewing the device 200 above in plan view but to hide the base of the wells from view when the device 200 is viewed from an angle to the side or end of the device.

The depth of the wells is typically dependent on the distance between the upper surface and lower surface between which the wells are defined. The depth is such so as to prevent a user from viewing a base of the wells when looking from a side or at an angle to the device.

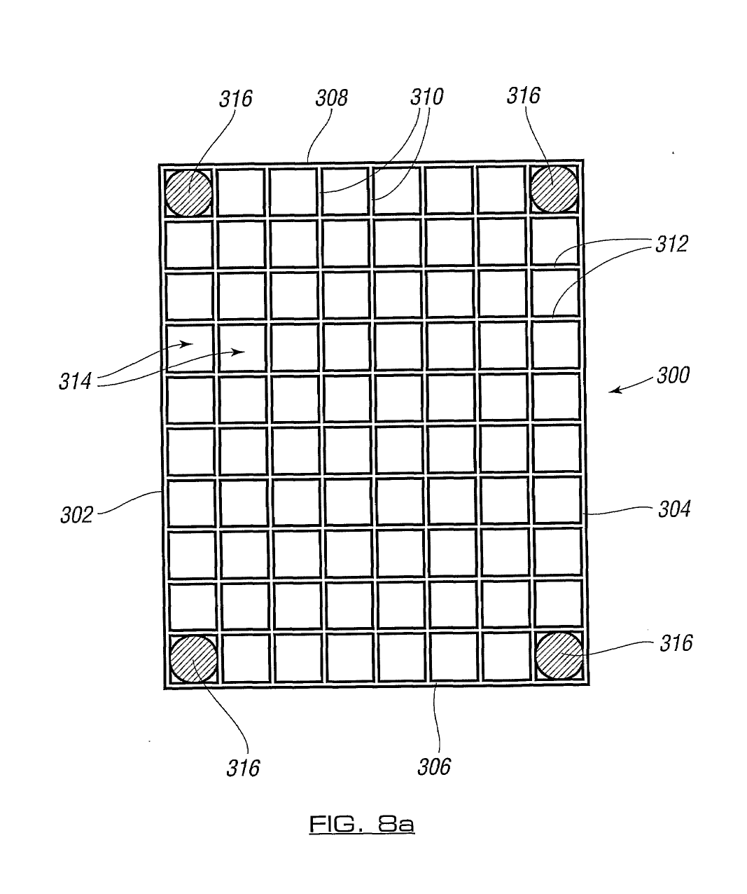

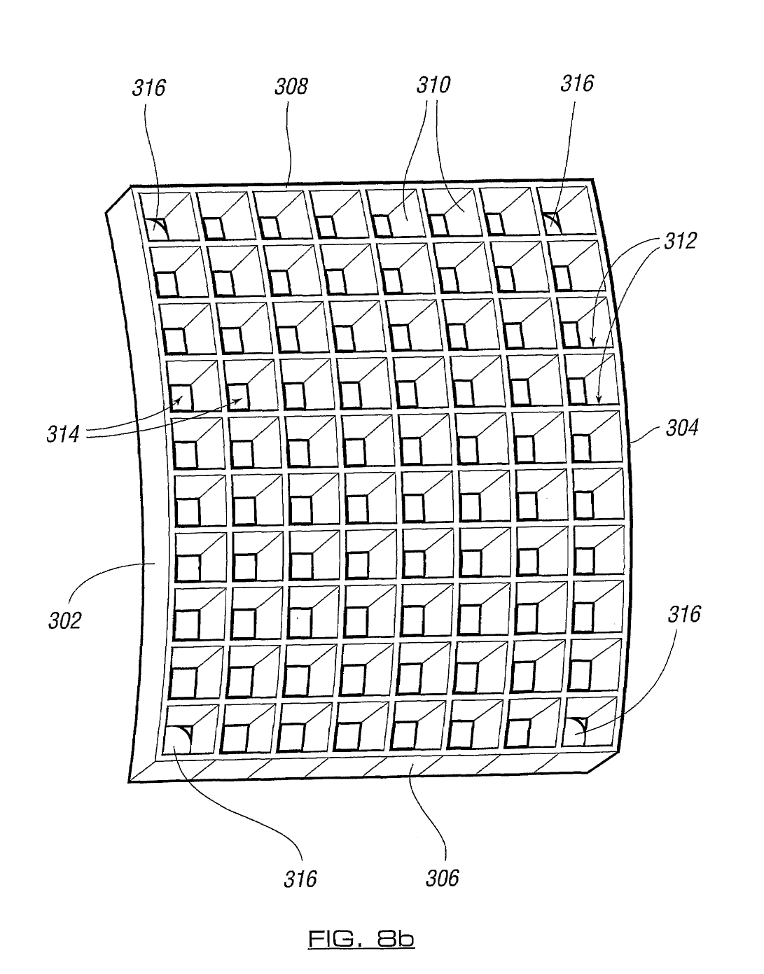

FIG. 8a illustrates a further shield device 300 having outer side walls 302, 304 and end walls 306, 308. A plurality of substantially vertical members 310 and substantially horizontal members 312 are located at spaced apart intervals to define a plurality of wells 314 therebetween. In order to ensure the authorized user is correctly positioned to allow the data to be easily viewed at the base of wells 314 without causing strain to the user's eyes, alignment or positioning means can be provided to indicate to the user when they are in a correct position. In the illustration, the positioning means includes four dots 316 located in each corner of device 300. The user is typically given instructions to align their head or eyes with the device 300 such that the total area of all four dots can be clearly seen, as shown in FIG. 8a, when the user's head is directly over device 300 (i.e. their line of vision is parallel to the longitudinal axis of the well depth). If the user is at an incorrect angle to the device, as shown in FIG. 8b, the user will not be able to see the full dots 316 in all four corners, and the user will therefore know they need to move their position.

Visual, audio, and/or kinaesthetic alarm means could be provided with the device 300 to indicate when a user's position is incorrect. A plurality of sensors, such as light sensors, could be used to signal to the alarm means when the user's position is incorrect.

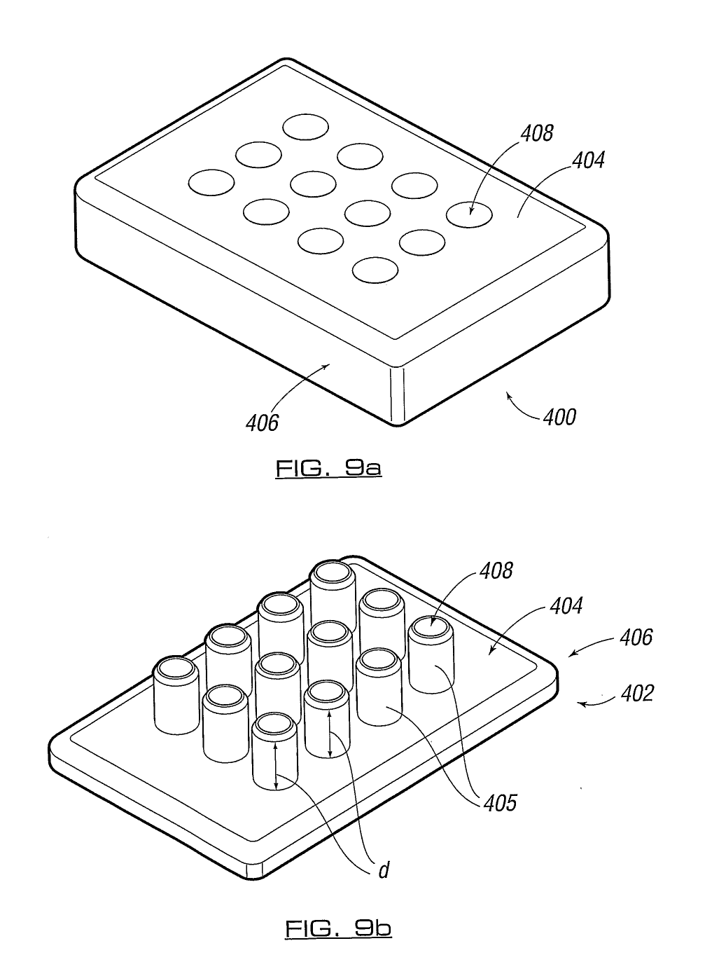

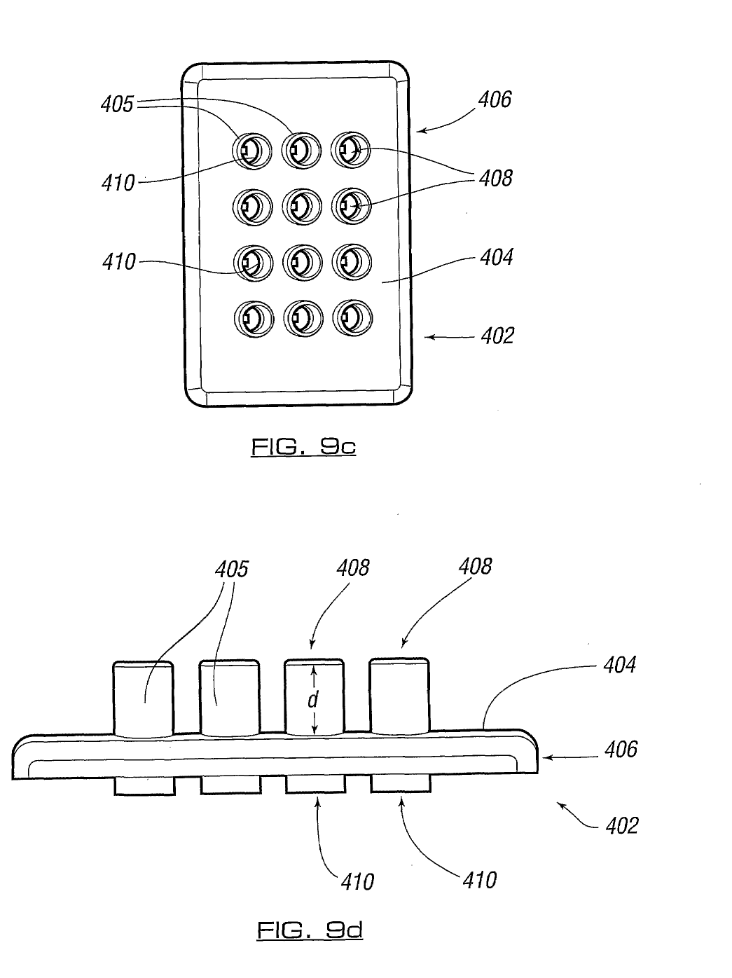

Further examples of possible shield devices 400, 402 are shown in FIGS. 9a and 9b-9d. In these embodiments, rather than the wells or channels being defined by inter-engaging first and second members forming a honeycomb or grid type of arrangement as in some of the previously described embodiments, the wells or channels 405 are each independently formed and provided a spaced distance apart. More particularly, FIGS. 9b-9d illustrate a perspective view, perspective view from the side and side view respectively of the shield device 402.

More particularly, the devices 400, 402 comprise an upper surface 404 of a plate or housing 406. The housing 406 is to be located above a plurality of data items or data input means as in previous described embodiments. The wells are typically in the form of a plurality of sleeves or channels which can be of any suitable shape, such as cylindrical, have a substantially rectangular cross section and/or the like. Each well has a first upper opening 408 and a second lower opening 410 (typically—defining a base of the well) with a channel having a pre-defined depth ‘d’ defined between said first and second openings 408, 410.

In the device 400 shown in FIG. 9a, the upper openings 408 of wells/channels 405 are substantially flush with upper surface 404 of housing 406. The depth of each well (not shown) protrudes below the upper surface 404 towards a lower surface of housing 406.

In the device 402 shown in FIGS. 9b-9d, wells 405 protrude outwardly of upper surface 404 and the upper openings 408 are located a depth ‘d’ above said upper surface 404. The lower opening 410 is typically located adjacent a lower surface of housing 406, below the lower surface (as is the case in the illustrated example) or located adjacent upper surface 404.

The depth ‘d’ of wells 405 is sufficient so as to obscure a user's view of the base of the wells, where data items or data input means are typically located, unless the user's head or vision is substantially in alignment or directly above housing 406. FIG. 9c shows that when the wells 405 are viewed from an angle, data items located at the base of the wells cannot be clearly seen, thereby preventing third party viewing of the data items being selected by a user.

The shield devices shown herein can be formed from any or any combination of suitable material, such as plastic, metal, wood, rubber and/or the like. The devices can be integrally formed, such as by injection moulding for example, or can be attached together using attachment means or inter-engaging parts. Thus, it can be seen that the present invention provides a vision deflector or shield device which prevents third parties from viewing data items or data input means on which the vision deflector is being used. In addition, the present invention is effective against an unauthorized third party trying to use security cameras or CCTV cameras in a retail outlet to view the input of a user's personal data into an identification system.

1-37. (canceled)

38. A shield device for use on at least one data input apparatus, said shield device comprising:
a frame adjacent to the data input apparatus, said frame comprising at least one channel defined therethrough, said at least one channel having a first channel end and a second channel end and arranged such that a user can view said first channel end in a first position when the user is looking through said second channel end and the user's line of vision is substantially parallel with a longitudinal axis of said at least one channel, thereby allowing the data input apparatus associated with or below said first channel end to be viewed by the user in the first position, the view of said first channel end being substantially obscured or shielded from the user in at least a second position when the user's line of vision is at an acute angle to said channel longitudinal axis.

39. The shield device according to claim 38, wherein said frame and one or more side walls defining said at least one channel are formed from substantially non-transparent or opaque material, thereby preventing viewing of said second channel end via said frame and said one or more side walls.

40. The shield device according to claim 38, wherein said first and second channel ends are open ends, and side walls defining said at least one channel are formed from substantially transparent material, thereby allowing a user looking through said channel at angles associated with said first position to view said first channel end from said second channel end.

41. The shield device according to claim 38, wherein said second channel end is substantially flush with an upper surface of said frame.

42. The shield device according to claim 38, wherein said second channel end is recessed in an upper surface of the housing or frame.

43. The shield device according to claim 38, wherein said at least one channel protrudes outwardly from an upper surface of said frame, and said second channel end is a spaced distance above said upper surface of said frame.

44. The shield device according to claim 38, wherein said channel being a plurality of channels defined in said frame, and wherein the data input apparatus is associated with or below each of said channels.

45. The shield device according to claim 38, wherein obscuring elements are provided in or associated with said at least one channel to further obscure the view of said first channel end when said second channel end is being viewed in said second position.

46. The shield device according to claim 45, wherein said obscuring elements are in the form of a grid or honey comb type of arrangement, wherein spacing between apertures in said grid or honey comb type of arrangement are such so as to allow said first channel end to be viewed when in said first position but to substantially obscure said first channel end when in said second position.

47. The shield device according to claim 45, wherein said obscuring elements include a plurality of members arranged between side walls and end walls defining said at least one channel, wherein spacing between said plurality of members are such so as to allow said first channel end to be viewed when in said first position but to substantially obscure said first channel end when in said second position, said members being arranged a spaced distance apart and substantially parallel to each other, and wherein said members being at least first and second sets of members, said first set of members being arranged a spaced distance apart and at a pre-determined angle relative to said second set of members, and wherein said first set of members are arranged substantially perpendicular to said second set of members.

48. The shield device according to claim 47 further comprising an adjustment system is provided to allow adjustment of the spacing and angle of the members relative to each other, and wherein said members are formed from sheet material having a planar surface, said planar surface of said sheet being arranged substantially parallel to said longitudinal axis of said channel.

49. The shield device according to claim 38 further comprising a support located a pre-determined spaced distance above an upper surface of the data input apparatus, thereby allowing the user to insert their hand or digit between a lower surface of said shield device and the upper surface of the data input apparatus to allow actuation of the data input apparatus.

50. The shield device according to claim 38, wherein said at least one channel is defined between one or more louvers members.

51. The shield device according to claim 38, wherein said shield device being movably mountable relative to the data input apparatus.

52. The shield device according to claim 38, wherein upper and lower surfaces of said frame are substantially planar in form.

53. The shield device according to claim 38, wherein upper and lower surfaces of said frame are substantially curved in form.

54. The shield device according to claim 38, wherein said frame further comprising one or more perforations to allow light to pass therethrough.

55. The shield device according to claim 39, wherein one or more side walls define said at least one channel, said side walls further comprising reflective material thereon to increase the light passing into said channel.

56. The shield device according to claim 39, wherein one or more side walls define said at least one channel, and wherein one or more surfaces of said side walls further comprising raised portions.

57. A method of using a shield device, said method comprising the steps of:
providing a shield device comprising a frame having at least one channel defined therethrough, wherein said at least one channel having a first channel end and a second channel end;
associating a data apparatus below said first channel end of said shield device so as to allow a user to view said shield device;
allowing said data apparatus to be viewed through said first channel end by the user in at least a first position when the user's line of vision is substantially parallel with a longitudinal axis of said channel while the user is looking through said second channel end; and
obscuring the view of said first channel end from the user in at least a second position when the user's line of vision is at an acute angle to said longitudinal axis of said channel.
